(19) United States
(12) Patent Application Publication
(10) Pub. No.: US 2009/0151465 A1
(43) Pub. Date: Jun. 18, 2009

(54) Miniature high pressure cell for sample characterization

(76) Inventor: Patricia Lebre Alireza, London (GB)

Correspondence Address: HARNESS, DICKEY & PIERCE, P.L.C., P.O. BOX 828, BLOOMFIELD HILLS, MI, 48303, US

(21) Appl. No.: 12/308,139

(22) PCT Filed: May 30, 2007
(86) PCT No.: PCT/GB2007/001996

§ 371 Date: Dec. 8, 2008

(30) Foreign Application Priority Data
Jun. 8, 2006 (GB) 0611353.4

(51) Int. Cl. G01L 7/16

(52) U.S. Cl. 73/744

(57) ABSTRACT

A miniature high pressure cell for sample characterization under pressure, comprising: a cell body defining a bore extending along an axis; first and second force transmitting elements mounted within said bore, said first and second force transmitting elements having respective first and second force transmitting faces which face towards each other in the axial direction; and a seal member positioned at least partially in said bore between said force transmitting elements, the seal member having walls defining a through-hole extending axially between respective sides and opening out towards respective force transmitting faces, said seal member and force transmitting elements being arranged such that, in use, the walls of said seal member defining said through-hole and portions of said force transmitting faces define the boundaries of a sealed sample volume in which a pressure transmitting medium and a sample to be characterized may be contained, wherein: at least one of said force transmitting elements is moveable so as to press said seal member between the faces; the miniature high pressure cell further comprising: a force locking apparatus for holding said force transmitting elements pressed against said seal member with a predetermined locking force, such that said sealed sample volume is held pressurized by said predetermined locking force; wherein said cell body includes a threaded portion and said force locking apparatus comprises at least one locking member with a threaded portion configured to cooperate with the threaded portion of said cell body, said threaded portions being coaxial with the axis of said bore and axially spaced from said seal member.

The present invention relates to a miniature high-pressure cell for sample characterization.

For many materials, characteristic physical properties such as the magnetizability or resistivity change as a function of external pressure. Monitoring pressure-induced changes of physical properties, using measurements carried out on samples held under pressure in a pressure cell, can reveal important information about the nature of particular materials and can be used to test and refine physical models that have been developed to describe such materials.

For sensitive measurements of physical properties, it is frequently necessary to introduce a sample of the material to be investigated into a spatially constrained “measurement region” of a measurement machine.

For example, where measurements are to be made in a magnetic field, it may be necessary to introduce the sample into a narrow high field region (often of a cylindrical bore shape) of a high field magnet. For higher, more uniform magnetic fields, which may be necessary to make the most sensitive measurements, the high field region generally has to be made smaller (or the magnet would become prohibitively expensive). Measurement regions with outer diameters restricted to 10 mm or less are relatively common for higher field and/or sensitivity measurements.

For non-pressurized samples, the fact that the measurement region is spatially restricted does not present a problem as the size of samples can easily be adapted to fit. The situation is different, however, when it is necessary to pressurize the samples while they are in the measurement region. In this case, it is the size of the pressure cell that has to be adapted and this can be more difficult.

Prior art systems have relied on miniaturization of the so-called piston-cylinder type pressure cell. These cells generate pressure by driving a tungsten carbide piston against a sample volume that is constrained laterally by the bore in which the piston slides. Pressure is transmitted to samples in the sample volume via a pressurizing fluid which is sealed in the sample volume by means of a teflon cap. A force locking mechanism such as a nut is provided to maintain the piston pressed against the sample volume with a pre-determined force.

Piston-cylinder cells are convenient because they are relatively easy to use (no elaborate alignment of the force-transmitting piston is necessary, for example) and they provide a relatively large sample volume (approximately equal to the area of the internal bore multiplied by the length of the sample volume, minus the volume of the teflon cap). However, the fact that the pressurizing force is intrinsically spread out over the cross-sectional area of the bore limits the pressure that can be achieved for a given force. As such cells are miniaturized, the mechanical strength of the cell walls, locking mechanisms and/or pistons effectively limit the maximum force and, therefore, the maximum pressure.

A miniature cell of the piston-cylinder type is being marketed by Quantum Design of 6325 Lusk Boulevard, San Diego, Calif. under the name of “Mcell 10”. This cell has an outer diameter of 8.5 mm and can reach a maximum pressure of 12 kbar. It is designed to operate in the bore of a commercial vibrating sample magnetometer (VSM) using SQUID (or “Superconducting Quantum Interference Device”) technology to measure the magnetization.

Although the pressure range of 0 to 12 kbar is useful for characterizing many materials, it would be desirable to extend the pressure range further to explore how pressure dependent properties evolve at higher pressures, but without increasing the size of the cell too much as this would rule out use of the cell in many of the best sample characterization systems currently available, which tend to have small measurement volumes. Access to higher pressures would not only allow a more complete investigation to be made of materials that have already been studied at lower pressures, but would open the way for pressure-studies of a wider range of materials and, in particular, of materials whose properties are not pressure-sensitive enough to show significant evolution in the 0 to 12 kbar range.

It is an object of the present invention to provide a method and means for pressurizing a sample to higher pressures in constrained measurement volumes.

According to an aspect of the invention, there is provided a method of pressurizing a sample in a miniature pressure cell, comprising: providing a seal member having walls defining a lateral boundary of a sample volume; placing a sample to be characterized and a pressurizing medium into said sample volume; forcing first and second force transmitting elements towards each other so as to press force transmitting faces of said force transmitting elements against opposite sides of said seal member, said force transmitting faces defining axial boundaries of said sample volume and acting to seal said sample volume; applying a force locking apparatus to hold said force transmitting elements pressed against said seal member with a predetermined locking force, said predetermined locking force acting to pressurize said sample volume to a desired pressure, wherein said force locking apparatus is applied by screwing a locking member into a locking position by means of cooperating threaded portions formed in said locking member and in said cell, said threaded portions being coaxial with a longitudinal axis of the cell and axially spaced from said seal member.

According to another aspect of the invention, there is provided a miniature high pressure cell for sample characterization under pressure, comprising: a cell body defining a bore extending along an axis; first and second force transmitting elements mounted within said bore, said first and second force transmitting elements having respective first and second force transmitting faces which face towards each other in the axial direction; and a seal member positioned at least partially in said bore between said force transmitting elements, the seal member having walls defining a through-hole extending axially between respective sides and opening out towards respective force transmitting faces, said seal member and force transmitting elements being arranged such that, in use, the walls of said seal member defining said through-hole and portions of said force transmitting faces define the boundaries of a sealed sample volume in which a pressure transmitting medium and a sample to be characterized may be contained, wherein: at least one of said force transmitting elements is moveable so as to press said seal member between the faces; the miniature high pressure cell further comprising: a force locking apparatus for holding said force transmitting elements pressed against said seal member with a predetermined locking force, such that said sealed sample volume is held pressurized by said predetermined locking force; wherein said cell body includes a threaded portion and said force locking apparatus comprises at least one locking member with a threaded portion configured to cooperate with the threaded portion of said cell body, said threaded portions being coaxial with the axis of said bore and axially spaced from said seal member.

The miniature pressure cell of the present invention can achieve pressures substantially higher than prior art high pressure cells of comparable size (i.e. cross-sectional diameter for cylindrical or pseudo-cylindrical cells) or smaller. According to one embodiment with a diameter of less than 9 mm, pressures in excess of 90 kbar have been recorded, which is around 8 times higher than the maximum working pressures obtainable with known systems of similar dimensions. The miniature size of cell is achieved by providing a locking mechanism that cooperates with the cell body by means of cooperating threaded portions on the locking member and cell, each coaxial with the axis of the bore of the cell and axially spaced from the seal member (i.e. such that there is a gap in the axial direction between the seal member and the first of the threads of the threaded portion of the cell body). The fact of being axially spaced means that the threaded portions of the locking member and cell can be provided with deep threads and a smaller outer diameter without impinging on the force transmitting elements or seal member.

Miniaturization is also helped by the way in which the pressure is generated. In contrast to the piston-cylinder type cells, in an embodiment of the invention, the pressure-transmitting medium is sealed in the sample volume in use between the inner surface of the through-hole in the planer seal member and faces of the force transmitting members being squeezed against the seal member (the resulting deformation of the seal member being such as to reduce the volume of the sample volume and pressurize the pressure-transmitting medium and sample). This arrangement allows the force to be applied to a much smaller area (the area of the force transmitting faces) than in the piston-cylinder cells because the lateral constraint of the pressure-transmitting medium is borne not by the walls of the cell bore but by the inner surface of the through-hole of the seal member. Thus, much smaller forces are needed to achieve a given pressure than would be the case with a piston-cylinder type cell and the force supporting walls of the cell and the locking device can be more easily miniaturized. Furthermore, because for a given size of cell the maximum locking force will be comparable, the maximum pressure obtainable using the present invention is significantly higher than that obtainable using the piston-cylinder design.

One potential concern with the present design is that the sample volume is so small in comparison with the piston-cylinder cell. Small sample volumes mean a corresponding reduction in the maximum size of sample that can be measured in the pressure cell, which in turn has an effect on the signal-to-noise achievable in certain sample characterization measurements. For example, an important application of the present invention is to measurements of magnetization under pressure. The size of the signal in such measurements is often proportional to the volume of the sample and is highly sensitive to background magnetization arising from magnetic materials in close proximity to the sample. However, it has been shown that problems with the small sample size can be overcome by minimisation and/or careful compensation of these background contributions to the measured signal. For example, it turns out that the magnetic contribution from the pressure cell can be reduced through careful choice of the material used for its construction. Ultra-pure Be—Cu, for example, has been shown to make a particularly low contribution to the background signal (e.g. 99.8% pure Be—Cu). Substantial variations have been observed in magnetic properties of Be—Cu of nominally identical purity produced by different manufacturers and further reductions of the background signal have been obtained by testing Be—Cu from a number of manufacturers and choosing that with the lowest magnetization.

At least one of the force transmitting elements may be mounted in a piston adapted to slide in the bore of the cell and the locking member may be configured to engage with an end of the piston distal from the force transmitting element mounted therein. An alternative arrangement with similar effect would be to form the force transmitting element so as integrally to comprise a portion shaped in the form of a piston for the cell bore at one end and a force transmitting face of reduced diameter at the other end. Whichever of the above two variations is chosen, the provision of a piston rigidly connected to the pressure transmitting face acts to encourage good alignment of the face perpendicular and centred to the axis of the bore. It is generally important to the reliable operation of the pressure cell, particularly at higher pressures, that the force transmitting faces are parallel to each other and aligned along a common axis.

Generally speaking, the longer the piston in which the force transmitting member is mounted, the better the alignment of the corresponding force transmitting face. Arranging for the locking member to engage with the cell body via threads that are axially spaced from the seal member facilitates the inclusion of long pistons by enabling the threads to be located in proximity to the end of the piston against which the locking mechanism will press.

Where both force transmitting members are mounted in pistons, accurate parallel alignment of the force transmitting faces may be achieved by providing elongated pistons for each.

Due to the small sample volume in comparison with piston-cylinder type cells, care is required when mounting samples in the sample volume, which may even have to be carried out with the aid of a microscope. In order to facilitate mechanical access (for insertion of samples, measurement wires etc.) and/or optical access (for viewing the sample volume during insertion of samples etc. and/or for carrying out measurements of the optical properties of the samples and/or materials such as ruby, which may be used for pressure calibration), an access window may be provided in a lateral wall of the cell body. The access window also facilitates introduction of the pressurizing medium, which could be a volatile liquid such as liquid argon, silicon oil or various solvents, for example. The access window allows the sample volume to be viewed easily with a microscope while the pressurizing medium is introduced, for example, thus minimizing the risk of the sample being washed away and lost. Such an access window is not possible in a piston-cylinder type cell because it would break the seal of the sample volume, which is maintained in part by the bore wall. In the present cell, however, the access window does not affect the sample volume because this is formed by the seal member in combination with faces of the force transmitting members. In addition, the reduced size of the force transmitting faces limits the size of the forces needed to be borne by the cell walls so that the reduction in cross-sectional area of the walls in the region of the access window and corresponding weakening of the cell can be tolerated.

The access window can also be exploited to provide extra room for the seal member. According to a preferred embodiment, the seal member is arranged to extend laterally beyond the internal diameter of the bore in the region of the access window. In this way, the seal member can extend up to the outer diameter of the cell without affecting the overall maximum outer diameter of the cell. Where two access windows are provided, radially opposite to each other, the seal member can extend across the whole outer diameter of the cell.

Extra room for the seal member makes it possible to provide a more effective seal member. This is partly because a larger seal member will provide better lateral support to the pressurized sample volume in use, and partly because the extra space will allow more effective mounting mechanisms (such as alignment pins to engage with alignment holes in the seal member) to be used for the seal member, thereby improving performance and reliability. Accurate alignment of the seal member relative to the cell bore can be an important factor and it is beneficial to be able to achieve this without modifying the seal member too near the sample volume (by drilling alignment holes in the seal member, for example), where the structural integrity of the seal member is important for pressure generation.

The access window also acts to reduce the amount of cell material in the region of the sample volume and therefore reduces background contributions to the signal. For example, where magnetization is being measured, the contribution from magnetic impurities inevitably present in the cell material is minimized.

The cell body may comprise non-threaded portions extended axially in both directions away from the seal member for a distance at least equal to an outer diameter of the cell. These non-threaded portions may provide the bore length necessary to allow extended pistons to be used within the bore (see above) for the purposes of aligning the force transmitting faces with each other.

A sample characterization system may comprise: a miniature high pressure cell as described above for containing a pressurized sample; and a measurement system configured to measure one or more physical properties of the pressurized sample. As mentioned above, the measurement system may be configured to measure the magnetization of the pressurized sample, for example. In any case, the invention is most applicable to measurement systems with spatially restricted sample measurement regions, for example sample regions having diameters of 9 mm or less.

Embodiments of the invention will now be described, by way of example only, with reference to the accompanying schematic drawings in which corresponding reference symbols indicate corresponding parts, and in which:

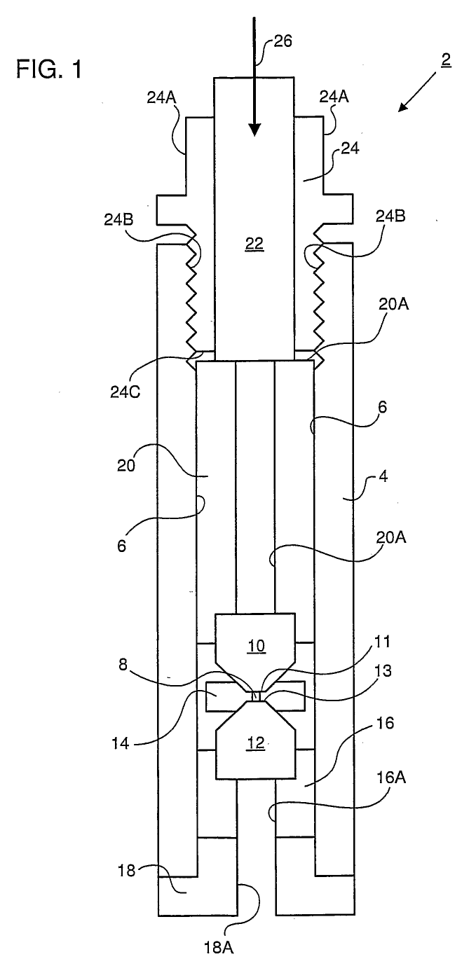

FIG. 1 is a sectional side view of a miniature pressure cell according to an embodiment of the invention;

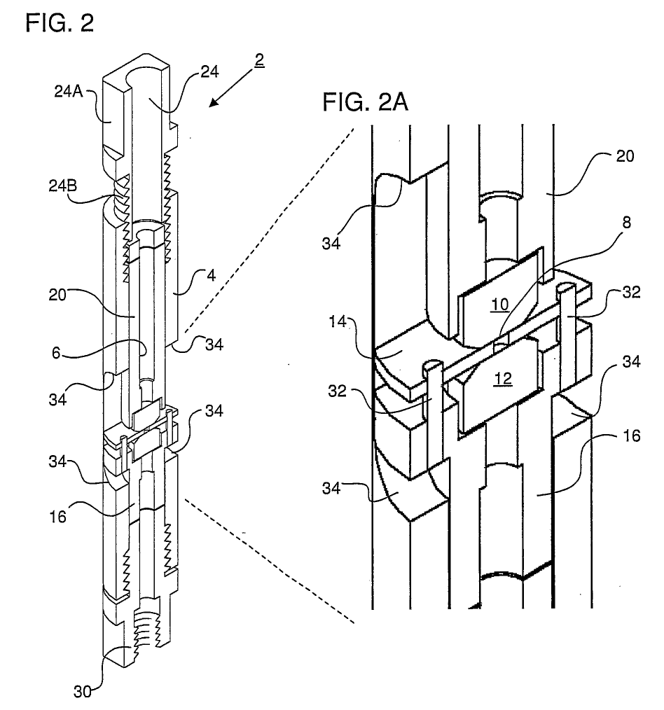

FIG. 2 is a perspective sectional view of a miniature pressure cell according to a further embodiment of the invention, comprising access windows and a laterally extended seal member;

FIG. 2A is a magnified view of the cell of FIG. 2 in the region of the seal member; and

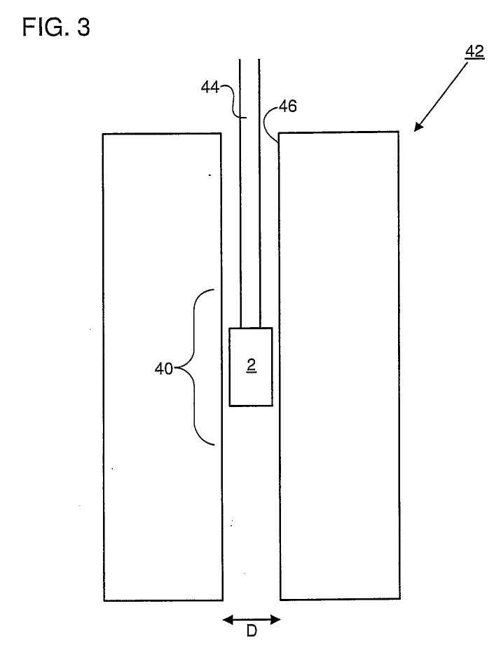

FIG. 3 is a schematic view of a sample characterization system according to an embodiment of the invention.

The miniature pressure cell of the present invention is designed to achieve pressures substantially higher than prior art high pressure cells of a comparable size or smaller. In particular, according to an embodiment of the invention, a miniature high-pressure cell is provided that has an outer diameter of less than 9 mm. Using a design according to an embodiment of the present invention, it has been possible to reach pressures in excess of 90 kbar, which is over 8 times higher than has been possible in prior art cells of similar dimensions.

FIG. 1 is a schematic illustration of a high pressure cylindrical cell 2 that has been cut lengthwise along a plane parallel to the axis of an internal bore 6.

The cell 2 comprises a cell body 4 having an internal bore 6 running down a central axis thereof. Both the cell body 4 and the internal bore 6 are preferably cylindrical as this allows for the largest cell volume for a given external diameter (“diameter” being defined relative to the circular cross-section of the cell).

Pressure is generated in a sample volume 8, which in use will contain a pressure transmitting medium such as a liquid (liquid argon or silicon oil, for example) and the sample or samples to be measured. The sample volume is delimited axially on either side by faces 11 and 13 of force transmitting elements 10 and 12 and laterally/radially by a seal member 14. The seal member 14 may be substantially planar and arranged to be perpendicular to the axis of the cell bore 6. Force applied axially via the force-transmitting elements causes the seal member 14 to deform inwards and pressurize the sample volume. The material of the seal member should be chosen so as to provide a suitable level of deformation and, at the same time, the necessary mechanical strength to support a required pressure. Example materials for the seal member 14 include hardened Be—Cu and phosphor-bronze. Where magnetic measurements are to be made, the seal member 14 should preferably have as small a magnetizability as possible so as to minimize any contribution to the background signal. The sample volume 8 is formed in the seal member 14 by means of a through-hole (formed for example by drilling). In the arrangement shown, force transmitting element 12 is mounted in a mounting member 16, which is prevented from moving axially away from the seal member by backing member 18 (which may be formed initially as a separate unit and connected to the cell later, for ease of manufacture for example, or may be formed as an integral part of the cell). The force transmitting element 10 is mounted in an elongated piston 20, which can move axially relative to the seal member 14.

Pressure is applied to the sample volume 8 by applying an axial force to a rear side 20A of the piston 20 in which the force transmitting element 10 is mounted. This may be achieved, for example, by means of a removable piston 22 and an external ram (not shown) configured to apply a force in the sense of arrow 26. Once a desired force has been reached, a force locking apparatus may be used to transfer the load applied by the external ram to the cell 2. According to the arrangement shown, the force locking apparatus includes a locking member 24 with a portion 24A shaped so as to engage with a spanner (or similar torque applying device) and an external male threaded portion 24B for engaging with a corresponding internal female threaded portion (or vice versa) of the cell body 4. Turning the locking member 24 about the axis of the cell bore 6 enables the locking member 24 to be moved axially towards or away from the seal member 14 by means of the thread. The applied force is transferred from the ram to the cell by turning the locking member 24 in such a way as to bring a leading face 24C of the locking member 24 against a rear edge 20A of the piston 20. Optionally, means may be provided to ensure that tightening of the locking member 24 in this way does not cause a tuning motion to be transferred to the piston 20 when the leading face 24C is in contact with the rear edge 20A of the piston 20. For example, a threaded hole or the like might be formed in the piston 20 so that a screw or similar can be inserted laterally into the piston through an opening (not shown) in the cell body 4 while the locking member 24 is tightened. Once the piston 20 is supported by the locking member 24, the force applied via piston 22 can be removed (and piston 22 can then be slid out of the cell through the opening in the locking member 24) and the force thereby transferred via the threads 24B to the locking member 24 and cell body 4. Removal of the piston 22 provides optical axis to the sample volume where the force transmitting elements 10 and 12 are transparent and openings 16A, 18A, 20A are provided in elements 16, 18 and 20.

The pressure obtained in the sample volume 8 depends, inter alia, on the force applied to the force transmitting elements 10 and 12 and the size of the leading faces 11 and 13 of the force transmitting elements 10 and 12 that are brought into contact with the seal member 14. In general, for a given force, the smaller the faces 11 and 13, the higher the pressure that is achieved. However, reducing the size of the faces 11 and 13 means that the sample volume 8 will also have to become smaller. In addition, it will become increasingly difficult to align the force transmitting elements 10 and 12 sufficiently accurately to ensure even distribution of forces across the faces 11 and 13 (which is normally necessary to avoid the risk of breakage and/or excessive lateral deformation of the sample volume). More generally, to achieve the highest pressures, the materials used for the force transmitting elements 10 and 12 must be chosen carefully to avoid breakage. Materials that have been found to have mechanical properties suitable for many applications include sapphire (single crystal), diamond (single crystal or scintered), and moissanite (single crystal). These particular materials also have the advantage of being transparent, which may be useful for measurements of the optical properties of samples and/or for general optical axis to the sample volume.

FIG. 2 shows an embodiment similar to that shown in FIG. 1 but with the added features of access windows 34 and a second threaded locking member engaged behind piston 16. In addition, the piston 22 for applying the initial force from the external ram is not shown (the corresponding cylindrical opening in the locking device 24 is therefore empty). Corresponding features have been given the same reference numerals in FIG. 2 as were used in FIG. 1 and again the view shown is of a cell cut along a plane lying lengthways parallel to the axis of the cell 2. The right-hand FIG. 2A shows an enlarged view of the region around the seal member 14. In contrast to the arrangement shown in FIG. 1, the provision of access windows 34 has allowed the seal member to be extended beyond the inner diameter of the bore 6 to a position close to the outer diameter of the cell 4 in directions leading to the access windows 34. This extension of the seal member 14 has allowed guiding pins 32 to be used to support and align the seal member 14 by means of corresponding alignment holes formed in the seal member 14. This extra support provides greater reliability and, because the alignment holes can be formed some distance away from the sample volume 8, the mounting is achieved without compromising the integrity of the physical structure of the seal member 14 in the region of the sample volume 8.

The second threaded locking member 30 is optional and, in the embodiment shown, the force from an external ram will only be transferred to the cell via movement of the upper locking member 24. During use, the lower second locking member 30 will be screwed into a fixed position and will not be moved during pressurization. However, providing the lower locking mechanism 30 as a separate entity, rather than as an integral part of the cell body 4, is convenient because the flat surface of the locking mechanism 30 against which the lower piston 16 sits can be more easily formed than the equivalent surface formed in the cell body (for example, at the end of a blind cell bore). The provision of threads in the locking member 30 is also convenient because it allows the axial position of the sample volume 8 to be adjusted easily, if necessary.

FIG. 3 shows a cross-sectional schematic view of a miniature pressure cell 2 inserted into a measurement system 42 of a sample characterization system according to an embodiment of the invention. In the arrangement shown, the miniature pressure cell 2 is mounted on a probe 44 to allow positioning of the miniature pressure cell 2 in a measurement region 40. An inner bore 46 of the measurement system 42 (which may lead to a high magnetic field region within coils of a high field electromagnet) has an inner diameter D of 9 mm. In order to fit within the measurement region 40, therefore, the pressure cell 2 must have an outer diameter of less than 9 mm. Using the miniature high pressure cell described earlier, high sensitivity measurements can be made (of magnetization for example) at pressures in excess of 90 kbar. Using a SQUID magnetometer, for example, magnetization under pressure can be measured with a sensitivity better than 10⁻⁵ emu, preferably as good as 10⁻⁶ emu, or even 10⁻⁷ emu, in a temperature range from 1.8K to 350K and in magnetic fields up to and exceeding 5T. These performance figures for sensitivity, temperature range and magnetic field range correspond to what is realisable in one particular measurement system but the design of the miniature pressure cell described above may also be applicable to measurement systems capable of more extreme performance. For example, embodiments of the invention could be adapted to operate in a dilution or adiabatic demagnetization refrigerator, which may be capable of cooling the pressure cell to below 100 mK, or even below 10 mK. Additionally or alternatively, the miniature pressure cell could be used in ultra-high magnetic fields, extending up to 16T, 18T or even higher.

1-13. (canceled)

14. A miniature high pressure cell for sample characterization under pressure, comprising:
a cell body defining a bore extending along an axis;
first and second force transmitting elements mounted within said bore, said first and second force transmitting elements having respective first and second force transmitting faces which face towards each other in the axial direction; and
a seal member positioned at least partially in said bore between said force transmitting elements, the seal member having walls defining a through-hole extending axially between respective sides and opening out towards respective force transmitting faces, said seal member and force transmitting elements being arranged such that, in use, the walls of said seal member defining said through-hole and portions of said force transmitting faces define the boundaries of a sealed sample volume in which a pressure transmitting medium and a sample to be characterized may be contained, wherein:
at least one of said force transmitting elements is moveable so as to press said seal member between the faces; the miniature high pressure cell further comprising:
a force locking apparatus for holding said force transmitting elements pressed against said seal member with a predetermined locking force, such that said sealed sample volume is held pressurized by said predetermined locking force; wherein
said cell body includes a threaded portion and said force locking apparatus comprises at least one locking member with a threaded portion configured to cooperate with the threaded portion of said cell body, said threaded portions being coaxial with the axis of said bore and axially spaced from said seal member; and
an outer diameter of said cell body is less than 9 mm.

15. The miniature high pressure cell according to claim 14, wherein at least one of said force transmitting elements is mounted in a piston adapted to slide in said bore and said locking member is configured to engage with an end of said piston distal from the force transmitting element mounted therein.

16. The miniature high pressure cell according to claim 14, wherein both force transmitting elements are mounted in pistons adapted to slide in said bore and said locking member is configured to engage with an end of at least one of the pistons that is distal from the pressure transmitting element mounted therein.

17. The miniature high pressure cell according to claim 15, wherein at least one of said pistons has a length substantially greater than a width of the miniature high pressure cell so as to facilitate parallel alignment of said force transmitting faces.

18. The miniature high pressure cell according to claim 16, wherein at least one of said pistons has a length substantially greater than a width of the miniature high pressure cell so as to facilitate parallel alignment of said force transmitting faces.

19. The miniature high pressure cell according to claim 14, wherein said force transmitting faces are substantially smaller than the cross-section of said bore.

20. The miniature high pressure cell according to claim 14, further comprising a first access window formed in a lateral wall of said cell body for providing access to said seal member.

21. The miniature high pressure cell according to claim 20, further comprising a second access window formed in a lateral wall of said cell body diametrically opposite said first access window.

22. The miniature high pressure cell according to claim 20, wherein said seal member extends laterally beyond an inner diameter of said bore into said first access window.

23. The miniature high pressure cell according to claim 21, wherein said seal member extends laterally beyond an inner diameter of said bore into at least one of said first access window and said second access window.

24. A sample characterization system comprising:
the miniature high pressure cell according to claim 14 for containing a pressurized sample; and
a measurement system configured to measure one or more physical properties of said pressurized sample.

25. The sample characterization system according to claim 24, wherein said measurement system is configured to measure the magnetization of said pressurized sample.

26. The sample characterization system according to claim 24, comprising at least one of the following properties: the ability to measure magnetization with a sensitivity better than 10⁻⁵ emu, the ability to measure said physical properties in a temperature range of 1.8K to 350K, and the ability to measure said physical properties in a magnetic field greater than 5T.

27. A method of pressurizing a sample in a miniature pressure cell, comprising:
providing a seal member having walls defining a lateral boundary of a sample volume;
placing a sample to be characterized and a pressurizing medium into said sample volume;
forcing first and second force transmitting elements towards each other so as to press force transmitting faces of said force transmitting elements against opposite sides of said seal member, said force transmitting faces defining axial boundaries of said sample volume and acting to seal said sample volume;
applying a force locking apparatus to hold said force transmitting elements pressed against said seal member with a predetermined locking force, said predetermined locking force acting to pressurize said sample volume to a desired pressure, wherein
said force locking apparatus is applied by screwing a locking member into a locking position by means of cooperating threaded portions formed in said locking member and in said cell, said threaded portions being coaxial with a longitudinal axis of the cell and axially spaced from said seal member; and
an outer diameter of said cell body is less than 9 mm.
